(19) United States
(12) Patent Application Publication
(10) Pub. No.: US 2018/0196900 A1
(43) Pub. Date: Jul. 12, 2018

(54) System and Method for Forecasting Values of a Time Series

(71) Applicant: TEOCO LTD., Rosh Ha'ayin (IL)

(72) Inventors: Ayal Weissman, Yakir (IL); Michael Livschitz, Givat Zeev (IL)

(73) Assignee: TEOCO LTD., Rosh Ha'ayin (IL)

(21) Appl. No.: 15/841,000

(22) Filed: Dec. 13, 2017

Related U.S. Application Data
(60) Provisional application No. 62/444,822, filed on Jan. 11, 2017.

(51) Int. Cl. G06F 17/50; H04W 16/22

(52) U.S. Cl. CPC G06F 17/5009; G06F 2217/16; H04W 16/22

(57) ABSTRACT

A system is disclosed for electronically forecasting values of a plurality of time series. The system receives a dataset, for example of a telecommunications network. A plurality of performance indicators (PIs) are generated from the dataset. Groups of PIs are generated by the system, so that each PI in a group corresponds to an autoregressive integrated moving average (ARIMA) model of that group. A first group of PIs is selected, and the system configures for each PI of the first group of PIs at least a parameter of the ARIMA model. Based on the configured ARIMA model, the system may generate predicted values for any PI of the first group. In some embodiments, a seasonal ARIMA (SARIMA) model may be used, to allow detection of seasonal behavior of the time series.

### CROSS-REFERENCE TO RELATED APPLICATION

The disclosure claims the benefit under 35 U.S.C. §1.119(e) of U.S. Provisional Patent Application Ser. No. 62/444,822 filed on Jan. 11, 2017, entitled “A System and Method for Forecasting Values of a Time Series,” to Weissman et al., the contents of all of which is incorporated herein by reference in its entirety.

### TECHNICAL FIELD

The disclosure relates to electronically predicting values of time series pertaining to performance indicators of a telecommunications network.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any conventional references on the basis of this section, unless otherwise indicated.

Telecommunication networks are increasingly complex, with measurements being received from practically every network element. Each network element may generate hundreds, if not thousands of measurements each day. In order to determine, for example, if a network element is malfunctioning, a system needs to determine what is the expected value for the measurement produced by the network element. One way of making such a determination is by generating a forecast of values with respect to, or respective of, a performance indicator and comparing actual values to the forecast. However, this strategy is intensive on computer processing resources, as it requires generating a forecasting model for each time series of the performance indicator.

It would therefore be useful to provide a solution which could improve on the conventional approaches.

### SUMMARY

According to an exemplary embodiment, a computerized method for performance indicator time series forecasting, the method can include: receiving, by at least one processor, a dataset of a telecommunications network from which a plurality of performance indicators (PIs) are generated; generating, by the at least one processor, a first group of PIs of the plurality of PIs, wherein each PI of the first group corresponds to a first autoregressive integrated moving average (ARIMA) model; configuring, by the at least one processor, for each PI of the first group of PIs at least a parameter of the ARIMA model; and generating, by the at least one processor, a predicted value for a first PI of the first group, based on the configured ARIMA model.

According to one exemplary embodiment, the method can include where the ARIMA model is a seasonal ARIMA (SARIMA) model.

According to one exemplary embodiment, the method can include where generating a first group of PIs further comprises: clustering, by the at least one processor, the first group of PIs respective of a seasonal variable of the SARIMA model.

According to one exemplary embodiment, the method can include where generating the predicted value for the first PI of the first group further comprises: selecting, by the at least one processor, a second PI of the first group of PIs, for which the dataset has information of the second PI at a time point in which to generate the predicted value for the first PI; and generating, by the at least one processor, the predicted value for the first PI based on the configured ARIMA model, and the information of the second PI at the time point.

According to one exemplary embodiment, the method can include where at least a portion of the PIs comprise at least one of: key performance indicators, or key quality indicators.

According to one exemplary embodiment, the method can include where the dataset is related to one or more network elements of the telecommunications network.

According to one exemplary embodiment, the method can include where a network element comprises at least one of: a physical component, a logical component, or a combination thereof.

According to one exemplary embodiment, the method can further include: updating, by the at least one processor, the dataset with the generated predicted value; and storing, by the at least one processor, the dataset in a storage device.

According to another exemplary embodiment, system of performance indicator time series forecasting can include: at least one processor; and at least one memory coupled to the at least one processor, the processor configured to: receive a dataset of a telecommunications network from which a plurality of performance indicators (PIs) are generated; generate a first group of PIs of the plurality of PIs, wherein each PI of the first group corresponds to a first autoregressive integrated moving average (ARIMA) model; configure for each PI of the first group of PIs at least a parameter of the ARIMA model; and generate a predicted value for a first PI of the first group, based on the configured ARIMA model.

According to yet another exemplary embodiment, a computer program product embodied on a nontransitory computer accessible medium, which when executed on at least one processor performs a computerized method for performance indicator time series forecasting, the method can include: receiving a dataset of a telecommunications network from which a plurality of performance indicators (PIs) are generated; generating a first group of PIs of the plurality of PIs, wherein each PI of the first group corresponds to a first autoregressive integrated moving average (ARIMA) model; configuring for each PI of the first group of PIs at least a parameter of the ARIMA model; and generating a predicted value for a first PI of the first group, based on the configured ARIMA model.

### BRIEF DESCRIPTION OF THE DRAWINGS

The foregoing and other objects, features and advantages will become apparent and more readily appreciated from the following detailed description taken in conjunction with the accompanying drawings, in which:

FIG. 1—is a schematic illustration of a forecasting system implemented according to an embodiment.

FIG. 2—is a schematic illustration of a telecommunication network with a forecasting server, implemented in accordance with an embodiment.

FIG. 3—is a graph of three time series corresponding to a similar SARIMA model, in accordance with an embodiment.

FIG. 4—is a graph of a first time series with intervals of missing values, in accordance with an embodiment.

FIG. 5—is a flowchart of a computerized method for generating forecasts respective of a time series, in accordance with an embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

A system is disclosed for forecasting values of a plurality of time series. The system receives a dataset, for example of a telecommunications network. A plurality of performance indicators (PIs) are generated from the dataset. Groups of PIs are generated by the system, so that each PI in a group corresponds to an autoregressive integrated moving average (ARIMA) model of that group. A first group of PIs is selected, and the system configures for each PI of the first group of PIs at least a parameter of the ARIMA model. Based on the configured ARIMA model, the system may generate predicted values for any PI of the first group. In some embodiments, a seasonal ARIMA (SARIMA) model may be used, to allow detection of seasonal behavior of the time series.

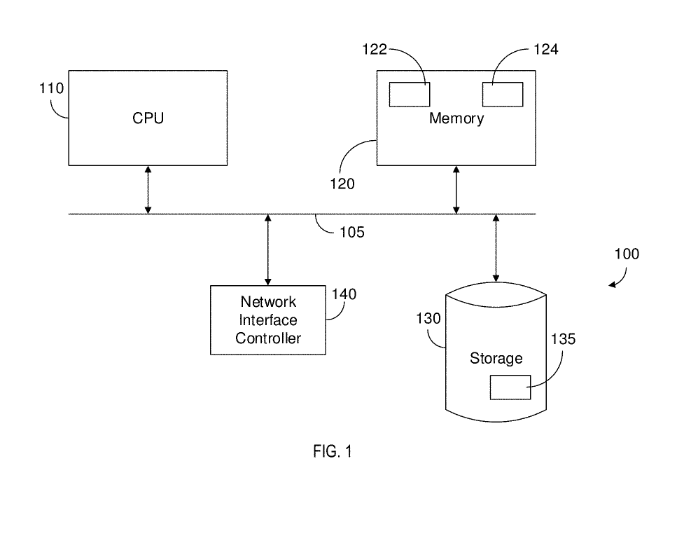

FIG. 1 is an exemplary and non-limiting schematic illustration of a forecasting system 100 implemented according to an embodiment. The system 100 includes at least one computer processing element 110, for example, a central processing unit (CPU). In an embodiment, the processing element 110 may be, or be a component of, a larger processing unit implemented with one or more processors. The one or more processors may be implemented with any combination of e.g.,but not limited to,general-purpose microprocessors, microcontrollers, multiprocessing cores, digital signal processors (DSPs), field programmable gate array (FPGA), programmable logic devices (PLDs), application specific integrated circuit (ASIC) controllers, state machines, gated logic, discrete hardware components, dedicated hardware finite state machines, systems on a chip (SOC), or any other suitable entities that can perform calculations or other manipulations of information. The processing element 110 is coupled via a bus 105 to a memory 120. The memory 120 may include a memory portion 122 that contains instructions that when executed by the processing element 110 performs the method described in more detail herein. The memory 120 may be further used as a working scratch pad for the processing element 110, a temporary storage, and others, as the case may be. The memory 120 may be a volatile memory such as, e.g., but not limited to random access memory (RAM), or non-volatile memory (NVM), such as, but not limited to, Flash memory, SDRAM, secondary storage devices, magnetic and/or optical storage devices, hard disk, optical disk, magneto-optical disk, compact disk (CD)-ROM, digital versatile disk (DVD), and the like. Memory 120 may further include memory portion 124 containing generated forecasted values of a time series. The system can include additional subsystems, not shown, such as e.g., but not limited to, input devices, output devices, sensors, touch screens, touch sensitive display panels, cryptographic subsystems, and/or video and/or audio subsystems, etc. The processing element 110 may be further coupled with a database 130 and/or database management system (DBMS). Database 130 may be used for the purpose of electronically holding a copy of the method executed in accordance with the disclosed technique. Database 130 may include storage portion 135 containing a plurality of autoregressive integrated moving average (ARIMA) models, seasonal ARIMA (SARIMA) models, combinations thereof, and the like. The processing element 110 may further be coupled with a network interface controller (NIC) 140, which is operative for connecting or coupling the forecasting server 110 to a telecommunication network. The processing element(s) 110 and/or the memory 120 may also include nontransitory machine-readable media for storing software. Software shall be construed broadly to mean any type of instructions, whether referred to as software, firmware, middleware, microcode, hardware description language, or otherwise. Instructions may include code (e.g., but not limited to, in source code format, binary code format, executable code format, or any other suitable format of code). The instructions, when executed by the one or more processors, cause the processing system to perform the various functions described in further detail herein.

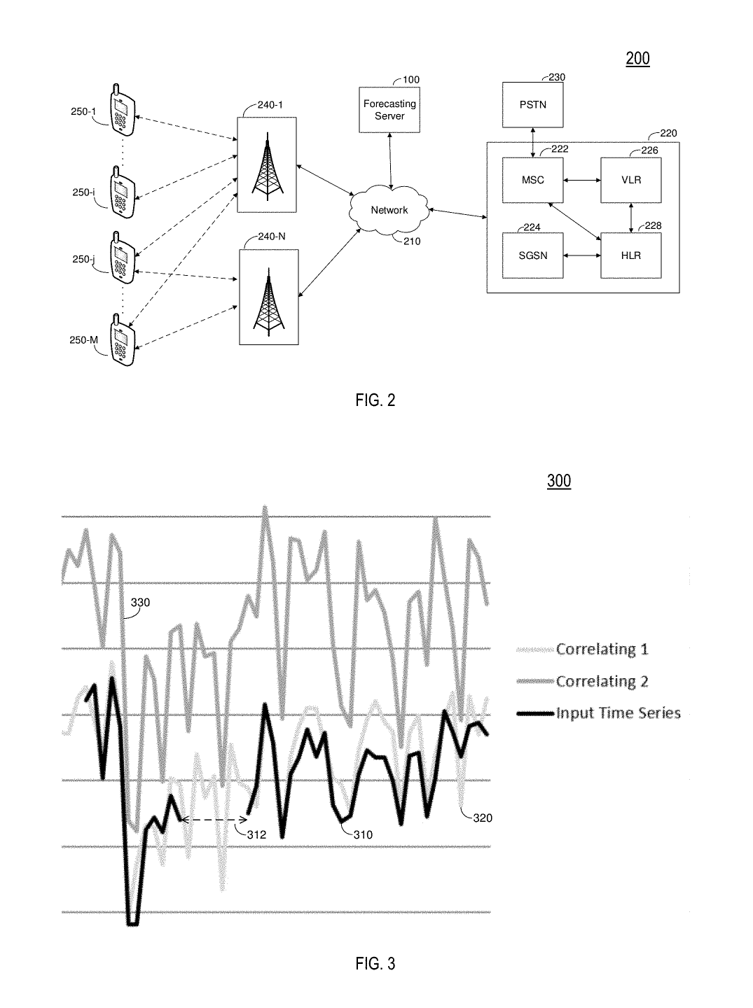

FIG. 2 is a non-limiting exemplary schematic illustration of a telecommunication network with a forecasting server, implemented in accordance with an embodiment. The telecommunication network includes in one embodiment a network 210, which may be configured to provide connectivity of various sorts, as may be necessary, including, e.g., but not limited to, wired and/or wireless connectivity, including, for example, but not limited to, local area network (LAN), wide area network (WAN), metro area network (MAN), worldwide web (WWW), personal area network (PAN), Internet, and any combination thereof, as well as cellular connectivity. The network 210 is further communicatively coupled with a core 220 of a Global System for Mobile communication (GSM) network. The core 220 includes in one embodiment, e.g., but not limited to, a Mobile Switching Center (MSC) 222, a Serving General Packet Radio Service (GPRS) Support Node (SGSN) 224, a Visitor Location Register (VLR) 226 and a Home Location Register (HLR) 228. The VLR 226 is communicatively coupled to the HLR 228 and MSC 222. HLR 226 is further communicatively coupled to the MSC 222 and the SGSN 224. MSC 222 is further communicatively coupled to a Public Switched Telephone Network (PSTN) 230. Core 220 is communicatively coupled through the network 210, to Radio Network Subsystem (RNS) 240-1 through RNS 240-N. A first group of user devices 250-1 through 250-i, are wirelessly communicatively coupled or connected to first RNS 240-1. A second group of user devices 250-j to 250-M are wirelessly communicatively connected or coupled to a second RNS 240-N. In some embodiments the forecasting server 100 may be coupled or connected directly to the core 220, or indirectly such as the example discussed above where the forecasting server 100 is coupled or connected to the core 220 over the network 210. In other embodiments, other mobile cellular systems, such as Universal Mobile Telecommunications System (UMTS) can be utilized with parallel components without departing from the scope of this disclosure. Components of the network 210, the core 220, the PSTN 230, and RNS 240-1 through 240-N, may each be a network element (NE) of the telecommunication network. Each such NE, components thereof, or logical combinations thereof, may generate measurements respective of the telecommunication network, which are collected and stored as raw data, from which a dataset may be generated. Performance indicators, such as, e.g., but not limited to, key performance indicators (KPIs), key quality indicators (KQIs) and the like may be generated from the dataset. Some measurement values can include a time stamp, and comprise together a time series, which may be analyzed by an autoregressive integrated moving average (ARIMA) model in one embodiment. Some time series have a seasonality to them, and are denoted as seasonal ARIMA (SARIMA) models. Such models behave differently in different time intervals, with a recurrence of the behavior. Measurements which the NEs generate may be, for example, dropped-call rate (DCR), call set-up success rate (CSSR), antenna transmission output, and the like. ‘N’, ‘M’, T and T are integers having a value of ‘1’ or greater.

FIG. 3 is a non-limiting exemplary graph of three time series corresponding to a similar SARIMA model, in accordance with an embodiment. Each time series corresponds to a key performance indicator (KPI), having a similar SARIMA model, according to an exemplary embodiment. A first time series 310 is missing values in certain intervals, such as interval 312, according to an exemplary embodiment. Predicting a value within the interval, for example, but not limited to, by linear interpolation, may lead to a wrong graph being generated for that interval. Each SARIMA model corresponding to time series 310, 320 and 330 is a variant of a single SARIMA model, according to an exemplary embodiment. By predicting a value for time series 310 based on the SARIMA model of time series 310, and further based upon data points of time series 320 and/or 330 at a time point within the interval, it is possible to generate a predicted value which is closer than what a simple linear operation can achieve, according to an exemplary embodiment. In certain embodiments, a greater accuracy can be achieved by predicting the value for time series 310 by further generating the predication or prediction based on an increasing number of time series with SARIMA models similar to the SARIMA model of time series 310, according to an exemplary embodiment.

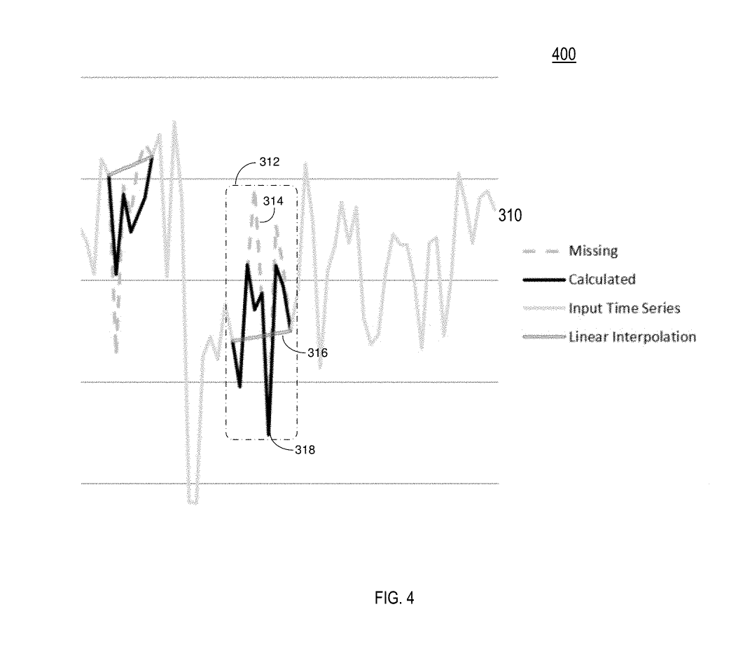

FIG. 4 is a non-limiting exemplary graph of a first time series 310 with intervals of missing values, in accordance with an embodiment. A first interval 312 is missing a plurality of values, according to an exemplary embodiment. Predicting these values, and comparing them to actual values (marked by dotted line 314) can be an indicator of the predicting system's ability to accurately predict future values of the time series, according to an exemplary embodiment. In this exemplary graph, two value prediction options are presented, according to an exemplary embodiment. One example is represented by a linear interpolation 316, and another set of predicted values 318 is generated by the forecasting system based on a SARIMA model configured to the first time series, according to an exemplary embodiment, and further based on at least another time series having a similar SARIMA model, such as time series 320 or 330, according to an exemplary embodiment.

Throughout this disclosure when noting an ARIMA (or other) model is similar to another ARIMA model, the reference typically implies that each such ARIMA model is derived from a single ARIMA model, with at least one parameter configured for a specific time series, according to an exemplary embodiment. Thus, the models are similar, but not identical, in an exemplary embodiment.

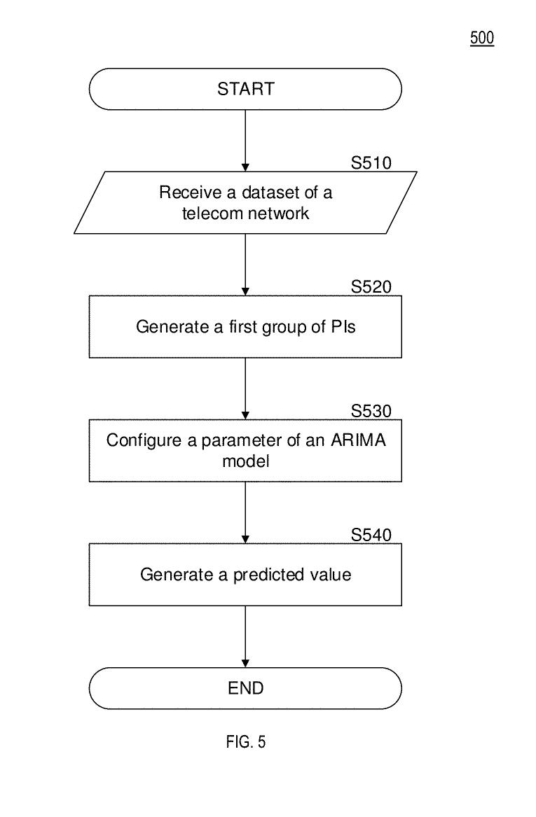

FIG. 5 is an exemplary non-limiting flowchart 500 of a computerized method for generating forecasts respective of or related to a time series, in accordance with an embodiment. In S510 a dataset of a telecommunications network is received, from which a plurality of performance indicators (PIs) may be generated, according to an exemplary embodiment. Each PI, according to an exemplary embodiment, includes a time series of values. The dataset is generated by a telecommunication network respective of or related to a plurality of network elements, according to an exemplary embodiment. In S520 a first group of PIs of the plurality of PIs is generated, according to an exemplary embodiment. Each PI of the first group corresponds to a first ARIMA model, according to an exemplary embodiment. Generation of the first group may be performed by clustering time series of the PIs, according to an exemplary embodiment. In some embodiments, the model may be a seasonal ARIMA (SARIMA) model. The first ARIMA model may be one of a plurality of ARIMA models, according to an exemplary embodiment. In S530, according to an exemplary embodiment, at least a parameter of the ARIMA model is configured for a first PI of the first group of PIs. The configured ARIMA model may be stored in a storage of the forecasting server. In S540, according to an exemplary embodiment, at least one predicted value for the first PI is generated, based on the configured ARIMA model. In some embodiments, a second PI of the first group of PIs is selected, for which the time series has information of the second PI at a time point in which to generate the predicted value for the first PI. The at least one predicted value is generated based on the configured ARIMA model, and the information of the second PI at the time point, according to an exemplary embodiment. The updated dataset with the generated predicted value may be stored in a storage device, such as storage 130, according to an exemplary embodiment. In some embodiments, a plurality of predicted values is generated for a time series of the first PI. The forecasting system 100 may further receive some, or all, of the actual values as they become available, according to an exemplary embodiment. A check may be performed to determine if an actual value is within a range of the predicted value, according to an exemplary embodiment. The range may be determined by one or more thresholds, in an exemplary embodiment. If an actual value is not within the range of the predicted value, according to an exemplary embodiment, an alert may be sent.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as e.g., but not limited to, one or more central processing units (“CPUs”), a memory, user interface, other subsystems, input/output devices, and/or input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as, e.g., but not limited to, an additional data storage unit and/or a printing unit. Furthermore, a non-transitory computer readable medium is any computer readable medium except for a transitory propagating signal.

Various application programs in exemplary embodiments can include, e.g., but are not limited to, database management systems, including, e.g., hierarchical, flat file, relational, and/or graph databases, etc., encryption/decryption algorithms and/or subsystem applications, graphical user interfaces, decision support systems, prediction systems, expert systems, artificial intelligence engines, machine learning and/or other rules-based engines and/or query systems, etc.

In statistics and econometrics, and in particular in time series analysis, an autoregressive integrated moving average (ARIMA) model is a generalization of an autoregressive moving average (ARMA) model. Both of these models are fitted to time series data either to better understand the data or to predict future points in the series (forecasting). ARIMA models are applied in some cases where data show evidence of non-stationarity, where an initial differencing step (corresponding to the “integrated” part of the model) can be applied one or more times to eliminate the non-stationarity, according to one exemplary embodiment.

The autoregressive (AR) part of ARIMA indicates that the evolving variable of interest is regressed on its own lagged (i.e., prior) values. The moving average (MA) part indicates that the regression error is actually a linear combination of error terms whose values occurred contemporaneously and at various times in the past. The integrated (I) portion indicates that the data values have been replaced with the difference between their values and the previous values (and this differencing process may have been performed more than once). The purpose of each of these features is to make the model fit the data as well as possible, according to one exemplary embodiment

Non-seasonal ARIMA models are generally denoted ARIMA(p,d,q) where parameters p, d, and q are non-negative integers, p is the order (number of time lags) of the autoregressive model, d is the degree of differencing (the number of times the data have had past values subtracted), and q is the order of the moving-average model. Seasonal ARIMA models are usually denoted ARIMA(p,d,q)(P,D,Q)m, where m refers to the number of periods in each season, and the uppercase P,D,Q refer to the autoregressive, differencing, and moving average terms for the seasonal part of the ARIMA model, according to one exemplary embodiment.

When two out of the three terms are zeros, the model may be referred to based on the non-zero parameter, dropping “AR”, “I” or “MA” from the acronym describing the model. For example, ARIMA (1,0,0) is AR(1), ARIMA(0,1,0) is I(1), and ARIMA(0,0,1) is MA(1), according to one exemplary embodiment.

ARIMA models can be estimated following the Box-Jenkins approach, according to one exemplary embodiment. The model can use an iterative three-stage modeling approach: 1. Model identification and model selection: making sure that the variables are stationary, identifying seasonality in the dependent series (seasonally differencing it if necessary), and using plots of the autocorrelation and partial autocorrelation functions of the dependent time series to decide which (if any) autoregressive or moving average component should be used in the model, according to one exemplary embodiment. 2. Parameter estimation using computation algorithms to arrive at coefficients that best fit the selected ARIMA model. An exemplary method can use maximum likelihood estimation or non-linear least-squares estimation. 3. Model checking by testing whether the estimated model conforms to the specifications of a stationary univariate process, according to one exemplary embodiment. In particular, the residuals should be independent of each other and constant in mean and variance over time, according to one exemplary embodiment. (Plotting the mean and variance of residuals over time and performing a Ljung-Box test or plotting autocorrelation and partial autocorrelation of the residuals can be helpful to identify misspecification), according to one exemplary embodiment. If the estimation is inadequate, one can return to step one and attempt to build a better model, according to one exemplary embodiment. Where real series are never stationary however much differencing is done, rather than using Box-Jenkins, one can use state space methods, as stationarity of the time series is then not required, according to one exemplary embodiment.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for performance indicator time series forecasting, the method comprising:
receiving, by at least one processor, a dataset of a telecommunications network from which a plurality of performance indicators (PIs) are generated;
generating, by the at least one processor, a first group of PIs of the plurality of PIs, wherein each PI of the first group corresponds to a first autoregressive integrated moving average (ARIMA) model;
configuring, by the at least one processor, for each PI of the first group of PIs at least a parameter of the ARIMA model; and
generating, by the at least one processor, a predicted value for a first PI of the first group, based on the configured ARIMA model.

2. The computerized method of claim 1, wherein the ARIMA model is a seasonal ARIMA (SARIMA) model.

3. The computerized method of claim 2, wherein generating a first group of PIs further comprises:
clustering, by the at least one processor, the first group of PIs respective of a seasonal variable of the SARIMA model.

4. The computerized method of claim 1, wherein generating the predicted value for the first PI of the first group further comprises:
selecting, by the at least one processor, a second PI of the first group of PIs, for which the dataset has information of the second PI at a time point in which to generate the predicted value for the first PI; and
generating, by the at least one processor, the predicted value for the first PI based on the configured ARIMA model, and the information of the second PI at the time point.

5. The computerized method of claim 1, wherein at least a portion of the PIs comprise at least one of:
key performance indicators, or
key quality indicators.

6. The computerized method of claim 1, wherein the dataset is related to one or more network elements of the telecommunications network.

7. The computerized method of claim 6, wherein a network element comprises at least one of:
a physical component,
a logical component, or
a combination thereof.

8. The computerized method of claim 1, further comprising:
updating, by the at least one processor, the dataset with the generated predicted value; and
storing, by the at least one processor, the dataset in a storage device.

9. A system of performance indicator time series forecasting comprising:
at least one processor; and
at least one memory coupled to the at least one processor, the processor configured to:
receive a dataset of a telecommunications network from which a plurality of performance indicators (PIs) are generated;
generate a first group of PIs of the plurality of PIs, wherein each PI of the first group corresponds to a first autoregressive integrated moving average (ARIMA) model;
configure for each PI of the first group of PIs at least a parameter of the ARIMA model; and
generate a predicted value for a first PI of the first group, based on the configured ARIMA model.

10. A computer program product embodied on a nontransitory computer accessible medium, which when executed on at least one processor performs a computerized method for performance indicator time series forecasting, the method comprising:
receiving a dataset of a telecommunications network from which a plurality of performance indicators (PIs) are generated;
generating a first group of PIs of the plurality of PIs, wherein each PI of the first group corresponds to a first autoregressive integrated moving average (ARIMA) model;
configuring for each PI of the first group of PIs at least a parameter of the ARIMA model; and
generating a predicted value for a first PI of the first group, based on the configured ARIMA model.
